(19) United States
(12) Patent Application Publication
(10) Pub. No.: US 2024/0343082 A1
(43) Pub. Date: Oct. 17, 2024

(54) PROCESSING MACHINE AND METHOD FOR TRACK PROCESSING

(71) Applicant: ROBEL Bahnbaumaschinen GmbH, Freilassing (DE)

(72) Inventor: Thomas Hölzlwimmer, Burgkirchen an der Alz (DE)

(21) Appl. No.: 18/631,285

(22) Filed: Apr. 10, 2024

(30) Foreign Application Priority Data
Apr. 17, 2023 (DE) 10 2023 203 452.2

(51) Int. Cl. B60F 1/00; B60F 1/04; E05B 29/00

(52) U.S. Cl. CPC B60F 1/005; B60F 1/043; E05B 29/00

(57) ABSTRACT

A processing machine for track processing includes a carrier, a displacement mechanism disposed at the carrier, at least one processing unit disposed at the carrier for processing a track and at least one handle for manually guiding the processing machine. The displacement mechanism includes at least one rail-ground displacement unit for displacing the processing machine on a rail and on the ground. The processing machine enables simple, flexible, operator-friendly and efficient track processing. A method for track processing is also provided.

### CROSS-REFERENCES TO RELATED APPLICATIONS

This application claims the priority, under 35 U.S.C. § 119, of German Patent Application DE 10 2023 203 452.2, filed Apr. 17, 2023; the prior application is herewith incorporated by reference in its entirety.

### FIELD AND BACKGROUND OF THE INVENTION

The invention relates to a processing machine and a method for track processing. In particular, the invention relates to a processing machine which can be moved on a first rail and supported on an adjacent second rail for track processing.

German Utility Model DE 20 2016 006 565 U1 discloses a processing machine for track machining in the form of a screwing machine. The screwing machine includes a supporting frame on which two flanged rollers are disposed one after the other in the longitudinal rail direction, so that the screwing machine can be moved manually on a first rail by a handle. A cantilever beam is disposed at the supporting frame with a track roller rotatably mounted thereto, so that the screwing machine is supported on an adjacent second rail. The cantilever beam with the track roller is easily detachably connected to the supporting frame. The screwing machine includes two screwing units which are fastened to the supporting frame on both sides of the flanged rollers so that screws disposed on both sides of the first rail can be tightened or loosened. Due to the fact that the screwing machine can be displaced on only one rail and is merely supported on the adjacent rail, the screwing machine can be easily placed on the track and removed from it.

### SUMMARY OF THE INVENTION

It is accordingly an object of the invention to provide a processing machine and a method for track processing, which overcome the hereinafore-mentioned disadvantages of the heretofore-known machines and methods of this general type and which enable simple, flexible, operator-friendly and efficient track processing.

With the foregoing and other objects in view there is provided, in accordance with the invention, a processing machine for track processing, comprising a carrier, a displacement mechanism disposed at the carrier, at least one processing unit disposed at the carrier for processing a track, and at least one handle for manually guiding the processing machine, wherein the displacement mechanism includes at least one rail-ground displacement unit for displacing the processing machine on a rail and on the ground. The displacement mechanism disposed on the carrier of the processing machine includes at least one rail-ground displacement unit for displacing the processing machine on a rail and on the ground. According to the invention, it has been recognized that with the processing machines known in the prior art, transport to the track to be processed is often difficult and user-unfriendly, as the processing machines are difficult or impossible to move manually on the ground and must therefore be regularly carried manually or transported to and from the site at great expense by auxiliary vehicles. Due to the fact that the displacement mechanism of the processing machine according to the invention includes at least one rail-ground displacement unit, simple, flexible and operator-friendly displacement of the processing machine on the ground to the track to be processed and displacement of the processing machine on a rail during track processing is possible. This improves the efficiency of the processing machine and track processing.

Preferably, the processing machine includes at least a first displacement unit and a second displacement unit disposed at the carrier. The first displacement unit is a rail-ground displacement unit. In contrast, the second displacement unit can be a rail displacement unit or a ground displacement unit or a rail-ground displacement unit. Preferably, both the first displacement unit is a rail-ground displacement unit and the second displacement unit is a rail-ground displacement unit. The first displacement unit and the second displacement unit are disposed one after the other in a longitudinal direction of the carrier, which corresponds to a longitudinal rail direction. The first rail-ground displacement unit and the second rail-ground displacement unit thus serve to arrange the carrier on the same rail. Preferably, the first displacement unit and the second displacement unit are disposed at the ends of the carrier in the longitudinal direction. The rail displacement unit is configured, for example, as a flanged roller or guiding roller. The ground displacement unit is configured as a wheel, for example.

The at least one rail-ground displacement unit, in particular the respective rail-ground displacement unit, is configured in an integrated manner. This means that the rail-ground displacement unit is not configured by a separate rail displacement unit and by a separate ground displacement unit, which are adjustable relative to one another, in particular adjustable in height, so that either the rail displacement unit or the ground displacement unit is in use.

The at least one rail-ground displacement unit, in particular the respective rail-ground displacement unit, is preferably disposed in a suspended manner at the carrier. Preferably, the rail-ground displacement unit includes a displacement base body, which is fastened to the carrier by an associated fastening element. The fastening element can be disposed on one or two sides of the displacement base body. In the case of a two-sided arrangement, the fastening element is configured in particular in a fork shape.

The processing machine serves, for example, for screwing, clipping, drilling, spike punching, spike pulling and/or grinding. Accordingly, the processing machine includes, for example, at least one screwing unit, at least one clipping unit, at least one drilling unit, at least one spike punching unit, at least one spike pulling unit and/or at least one grinding unit as a processing unit. The at least one processing unit is disposed on the carrier in the longitudinal direction of the carrier, in particular between the first displacement unit and the second displacement unit. In particular, the at least one processing unit is disposed in a suspended manner at the carrier.

In particular, the processing machine can be guided and/or operated manually. Preferably, the processing machine is configured to be displaceable, in particular movable, on a first rail and supportable on an adjacent second rail.

A processing machine in which the at least one rail-ground displacement unit forms a running surface which includes at least one ground running surface and at least one rail running surface ensures simple, flexible, operator-friendly and efficient track processing. Due to the fact that the at least one rail-ground displacement unit, in particular the respective rail-ground displacement unit, forms a running surface including at least one ground running surface and at least one rail running surface, the rail-ground displacement unit is constructed in an integrated manner. The at least one ground running surface and the at least one rail running surface are disposed next to each other in a transverse direction of the processing machine. The transverse direction runs transversely, in particular perpendicularly, to the longitudinal direction of the carrier.

The at least one rail-ground displacement unit, in particular the respective rail-ground displacement unit, includes a displacement base body. The displacement base body can be constructed from a metallic material, a plastic material and/or a wooden material. The at least one ground running surface and/or the at least one rail running surface can be directly configured by the displacement base body. The displacement base body can be configured with a round or polygonal cross-section with rounded corners.

The at least one rail-ground displacement unit, in particular the respective rail-ground displacement unit, includes in particular at least one contact element disposed on a displacement base body. The at least one contact element preferably forms the at least one ground running surface and/or the at least one rail running surface. The at least one contact element can be constructed from a metallic material, a plastic material and/or an elastomer material. The plastic material includes, for example, a thermoplastic plastic material and/or a thermosetting plastic material. The at least one contact element is disposed in particular in a fixed and/or displaceable manner at the displacement base body. In particular, the at least one contact element can be displaced in a circumferential direction around the displacement base body and/or can be displaced in a transverse direction, i.e. laterally to the displacement base body.

The at least one contact element is configured in particular as a chain and/or belt, for example as a metal chain, rubber chain and/or rubber belt. In particular, the chain and/or the belt is configured to run around the displacement base body and is of closed configuration. The chain and/or the belt is disposed at the displacement base body and is preferably displaceable in a circumferential direction around the displacement base body and/or in a transverse direction, i.e. laterally to the displacement base body. The chain and/or the belt preferably form the at least one ground running surface and/or the at least one rail running surface.

The at least one contact element is configured in particular as a ring. In particular, the ring is constructed from a metallic material, a plastic material and/or an elastomer material. Preferably, a first ring and a second ring are disposed as contact elements at the displacement base body, which is configured in the shape of a wheel or round in cross-section. Preferably, at least one ring, in particular both rings, can be displaced in a transverse direction relative to the displacement base body. In particular, the at least one ring forms the at least one ground running surface and/or the at least one rail running surface. Preferably, the displacement base body forms a rail running surface and two rings each form a ground running surface.

Preferably, the at least one ground running surface has a greater distance than the at least one rail running surface from a central longitudinal axis of the displacement base body. In particular, the at least one ground running surface has a distance A_{G}, wherein in particular: 5 cm≤A_{G}≤30 cm, in particular 10 cm≤A_{G}≤25 cm, and in particular 15 cm≤A_{G}≤20 cm. The at least one rail running surface has in particular a distance A_{S} from a central longitudinal axis of the displacement base body, wherein the following applies in particular for the distance A_{S}: 4 cm≤A_{S}≤29 cm, in particular 9 cm≤A_{S}≤24 cm, and in particular 14 cm≤A_{S}≤19 cm. For a difference ΔA=A_{G}−A_{S}, in particular: 1 cm≤ΔA≤8 cm, in particular 2 cm≤ΔA≤7 cm, and in particular 3 cm≤ΔA≤6 cm.

Preferably, the at least one ground running surface is configured to be profiled in a circumferential direction and/or in a transverse direction of the displacement base body. In particular, the at least one ground running surface has elevations in a circumferential direction and/or in a transverse direction of the displacement base body. The elevations are configured in particular as knobs and/or studs.

A processing machine in which the at least one rail-ground displacement unit forms a running surface which includes two ground running surfaces and a rail running surface disposed therebetween ensures simple, flexible, operator-friendly and efficient track processing. Due to the fact that the rail running surface is configured in a transverse direction between the two ground running surfaces, the running surface can be adapted to the cross-section of a rail. Preferably, a distance A_{G} of the ground running surfaces from a central longitudinal axis of the displacement base body is greater than a distance A_{S} of the rail running surface, so that the running surface forms a recess for receiving a rail head of the rail. The distance between the two ground running surfaces can be adjusted, in particular in a transverse direction, i.e. in the direction of the central longitudinal axis of the displacement base body. This allows the running surface to be adapted to rail heads of different widths. For example, the ground running surfaces are configured by two rings that are disposed adjustably on a wheel-shaped or cross-sectionally round displacement base body. An adjustment mechanism serves in particular for adjustment. The adjustment mechanism can preferably be locked in a desired position.

A processing machine in which the at least one rail-ground displacement unit forms a running surface with a recess for receiving a rail head of a rail ensures simple, flexible, operator-friendly and efficient track processing. Viewed in cross-section, the running surface forms, at least in sections, a recess for receiving a rail head of a rail. This allows the at least one rail-ground displacement unit, in particular the respective rail-ground displacement unit, to be guided and displaced on a rail in a simple and operator-friendly manner. Due to the recess, the running surface is centered relative to the rail itself. In particular, the recess has a widening cross-section. The widening cross-section is preferably formed in a V-shape and/or U-shape. In particular, the cross-sectional shape of the recess can be adjusted, for example due to the fact that at least one ground running surface can be displaced relative to a rail running surface, in particular in a transverse direction of a displacement base body. This allows the recess to be adapted to different sizes of rail heads. For example, the ground running surface is formed by a ring which is fastened to the displacement base body so as to be adjustable in a transverse direction.

The at least one rail-ground displacement unit, in particular the respective rail-ground displacement unit, preferably forms a running surface which includes two ground running surfaces and a rail running surface disposed therebetween. Preferably, the ground running surfaces are configured to be profiled in a circumferential direction and/or in a transverse direction of the displacement base body. In particular, the at least one ground running surface has elevations in a circumferential direction and/or in a transverse direction of the displacement base body. The elevations are configured in particular as knobs and/or studs. In particular, the elevations have a chamfer and/or a rounding towards the rail running surface. This allows the running surface to adapt to rail heads of different widths without the need for adjustment.

A processing machine in which the at least one rail-ground displacement unit includes a displacement drive ensures simple, flexible, operator-friendly and efficient track processing. Preferably, a rail-ground displacement unit or a plurality of rail-ground displacement units or each rail-ground displacement unit includes an associated displacement drive. The respective displacement drive is configured in particular as an electric drive motor. The respective displacement drive serves in particular to drive a displacement base body of the rail-ground displacement unit about a central longitudinal axis and/or to drive a contact element in the circumferential direction about a displacement base body of the rail-ground displacement unit. The displacement drive can be integrated into the associated displacement base body. In particular, the processing machine includes a control device for controlling the respective displacement drive. In particular, the control device is configured in such a manner that the displacement drives can be controlled independently of and/or synchronously with one another.

A processing machine in which the displacement mechanism includes at least one steering unit ensures simple, flexible, operator-friendly and efficient track processing. The at least one steering unit enables simple displacement or moving of the processing machine on the ground. Preferably, the at least one steering unit serves to swivel at least one displacement unit, in particular a rail-ground displacement unit, relative to the carrier. In particular, the at least one steering unit can be swiveled about a vertical swivel axis relative to the carrier. The at least one steering unit preferably serves for manual swiveling. The at least one steering unit includes, for example, a swivel bearing, a steering linkage and/or at least one handle, in particular at least two handles. Preferably, the at least one steering unit is connected to an associated displacement unit, in particular a rail-ground displacement unit, which includes a displacement drive.

A processing machine in which the displacement mechanism includes a first rail-ground displacement unit and a second rail-ground displacement unit, which are disposed at a distance from one another at the carrier in a longitudinal direction, ensures simple, flexible, operator-friendly and efficient track processing. The first rail-ground displacement unit and the second rail-ground displacement unit are disposed in particular at the end and/or in a suspended manner at the carrier. The longitudinal direction corresponds to a longitudinal rail direction. Due to the fact that the rail-ground displacement units are disposed in a suspended manner at the carrier, the rail-ground displacement units and the carrier delimit a receiving space which is open towards a rail. The at least one processing unit and/or an energy supply unit is disposed in the receiving space. In particular, the at least one processing unit and/or the energy supply unit is disposed in a suspended manner at the carrier.

A processing machine in which the at least one processing unit is disposed in the longitudinal direction between the first rail-ground displacement unit and the second rail-ground displacement unit ensures simple, flexible, operator-friendly and efficient track processing. In particular, the at least one processing unit is disposed in a suspended manner at the carrier. Preferably, a first processing unit is disposed on a first side of the carrier and a second processing unit is disposed on a second side of the carrier between the rail-ground displacement units. This enables track processing on two sides of a rail.

A processing machine in which the displacement mechanism includes a first steering unit for swiveling the first rail-ground displacement unit and a second steering unit for swiveling the second rail-ground displacement unit relative to the carrier ensures simple, flexible, operator-friendly and efficient track processing. Due to the fact that the processing machine includes two steering units, it is extremely simple and operator-friendly to move the track processing machine on the ground, as well as to place the processing machine on the track and remove it from the track. The steering units can be actuated dependently and/or independently of each other. Preferably, the steering units can be coupled to and/or decoupled from each other. In particular, the steering units serve to manually steer the processing machine. Preferably, the respective steering unit includes a swivel bearing and/or a steering linkage and/or at least one handle, preferably at least two handles. The steering unit, which swivels the rail-ground displacement unit facing away from an operator, can include or form a parallel guide. Preferably, the carrier, together with a longitudinal rod and two transverse rods, forms a parallel guide which enables the rail-ground displacement unit facing away from the operator to be swiveled easily.

A processing machine in which the at least one processing unit is disposed in a suspended manner at the carrier ensures simple, flexible, operator-friendly and efficient track processing. Due to the suspended arrangement of the at least one processing unit at the carrier, the track processing can be freely observed by an operator. This enables simple positioning of the at least one processing unit. Preferably, a first processing unit is disposed in a suspended manner on a first side and a second processing unit on a second side of the carrier. The first side is located opposite the second side in a transverse direction relative to the carrier.

A processing machine in which a first processing unit is disposed in a transverse direction on a first side of the carrier and a second processing unit is disposed on an opposite second side of the carrier ensures simple, flexible, operator-friendly and efficient track processing. The two processing units enable efficient track processing, for example screwing or clipping on two sides of a rail. Preferably, the processing units are configured identically. Preferably, the processing machine includes a control mechanism for controlling the processing units. The processing units can be positioned and/or controlled independently of and/or synchronously with one another.

A processing machine including a positioning mechanism for positioning the at least one processing unit ensures simple, flexible, operator-friendly and efficient track processing. The positioning mechanism serves to position the at least one processing unit in a vertical direction and/or horizontal direction. Preferably, a plurality of processing units has at least one associated positioning mechanism, in particular one associated positioning mechanism each. In particular, the positioning mechanism includes at least one positioning drive for positioning the at least one processing unit in a vertical direction and/or horizontal direction. Preferably, the positioning mechanism includes a detection unit which detects the track processing task to be performed, so that the positioning mechanism automatically positions the at least one processing unit. For this purpose, the processing machine has, in particular, a control mechanism that is in signal communication with the positioning mechanism. In particular, the control mechanism evaluates measurement data from the detection unit and uses this data to generate control signals for the at least one positioning mechanism and/or the at least one processing unit.

A processing machine in which the displacement mechanism includes a cantilever beam for being supported on a rail ensures simple, flexible, operator-friendly and efficient track processing. The at least one processing unit disposed at the carrier is disposed on a rail, in particular on exactly one rail, by at least two displacement units. Through the use of the cantilever beam, the carrier with the at least one processing unit disposed thereon is supported on the adjacent second rail. For this purpose, the cantilever beam has at least one transverse rod. The transverse rod is used to provide support on the adjacent second rail. Preferably, the cantilever beam includes at least one supporting roller, which is rotatably mounted on the transverse rod. The at least one supporting roller rests on the adjacent second rail during operation.

Alternatively, the transverse rod can be connected to a further carrier on which at least two further displacement units and at least one further processing unit are disposed in order to carry out simultaneous track processing in the region of the second rail. The transverse rod is thus supported on the adjacent rail via the at least two further displacement units.

The cantilever beam is fastened to the carrier. Preferably, the cantilever beam is detachably fastened to the carrier, so that the cantilever beam can be dismantled for displacement on the ground and/or for placing the processing machine on the track and removing it from the track. Preferably, the cantilever beam includes a holder through the use of which the transverse rod is fastened at a distance from the carrier in a vertical direction. The holder can be connected to the carrier in one piece or fastened to the carrier in a detachable manner.

A processing machine including a power supply unit, which is disposed in particular at the carrier, ensures simple, flexible, operator-friendly and efficient track processing. The energy supply unit serves in particular to provide electrical energy. Preferably, the energy supply unit includes at least one accumulator. In particular, the accumulator is rechargeable and/or replaceable. The energy supply unit is disposed at the carrier, in particular in a suspended manner. Preferably, the energy supply unit is disposed between a first displacement unit and a second displacement unit. Preferably, the energy supply unit serves to supply the at least one processing unit and/or a displacement drive with energy, in particular with electrical energy. Preferably, the energy supply unit includes an adjustment mechanism for adjusting the position of the energy supply unit in a transverse direction relative to the carrier. This allows the center of gravity of the energy supply unit to be shifted in the transverse direction towards an adjacent second rail, so that the stability of the processing machine in conjunction with a cantilever beam is improved.

It is also an object of the invention to provide a method for track processing that is simple, flexible, operator-friendly and efficient.

With the objects of the invention in view, there is concomitantly provided a method for track processing, comprising the steps of providing a processing machine according to the invention, displacing the processing machine on the ground to a track and on a rail of the track by using the at least one rail-ground displacement unit, and processing the track by using the at least one processing unit. The advantages of the method according to the invention correspond to the advantages of the processing machine according to the invention already described. In particular, the method according to the invention can be further developed with any feature described in connection with the processing machine according to the invention.

In particular, the at least one rail-ground displacement unit forms a running surface including at least one ground running surface and at least one rail running surface. The processing machine is basically displaced on the ground by the at least one ground running surface. The at least one ground running surface has sufficient grip on the ground so that the processing machine can be displaced, in particular moved, to the track to be processed in a simple, flexible, operator-friendly and efficient manner. In contrast, the at least one rail running surface, in particular in conjunction with the at least one ground running surface, enables simple and operator-friendly displacement on a rail of the track. For this purpose, the running surface is configured in particular with a recess so that the running surface centers itself relative to the rail.

Preferably, the at least one rail-ground displacement unit has an associated steering unit. Preferably, the processing machine includes a first steering unit for swiveling a first rail-ground displacement unit and a second steering unit for swiveling a second rail-ground displacement unit relative to the carrier. The steering units can be swiveled in the same directions and/or in opposite directions, in particular they can be swiveled manually by an operator. If the steering units are swiveled in the same directions and by the same angles, the processing machine is displaced, in particular linearly and at an angle, i.e. transversely. If, on the other hand, the steering units are swiveled in opposite directions, the processing machine is displaced in particular along a curve.

Other features which are considered as characteristic for the invention are set forth in the appended claims.

Although the invention is illustrated and described herein as embodied in a processing machine and a method for track processing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a plan view onto a processing machine for track processing according to a first exemplary embodiment;

FIG. 2 is a plan view onto the track processing machine shown in FIG. 1 without the track to be processed;

FIG. 3 is a side view of the processing machine in FIG. 1;

FIG. 4 is a section through the processing machine along section line IV-IV in FIG. 3;

FIG. 5 is a side view of a processing machine for track processing according to a second exemplary embodiment;

FIG. 6 is a plan view onto the processing machine in FIG. 5;

FIG. 7 is a plan view onto the processing machine in FIG. 5 in a first steering position;

FIG. 8 is a plan view onto the processing machine in FIG. 5 in a second steering position;

FIG. 9 is a side view of a processing machine for track processing according to a third exemplary embodiment;

FIG. 10 is a plan view onto the processing machine in FIG. 9;

FIG. 11 is a plan view onto the processing machine in FIG. 9 in a first steering position;

FIG. 12 is a plan view onto the processing machine in FIG. 9 in a second steering position;

FIG. 13 is an enlarged front view of a rail-ground displacement unit of the processing machine in FIG. 9 in a setting for a wide rail head; and

FIG. 14 is an enlarged front view of the rail-ground displacement unit in FIG. 13 in a setting for a narrow rail head.

### DETAILED DESCRIPTION OF THE INVENTION

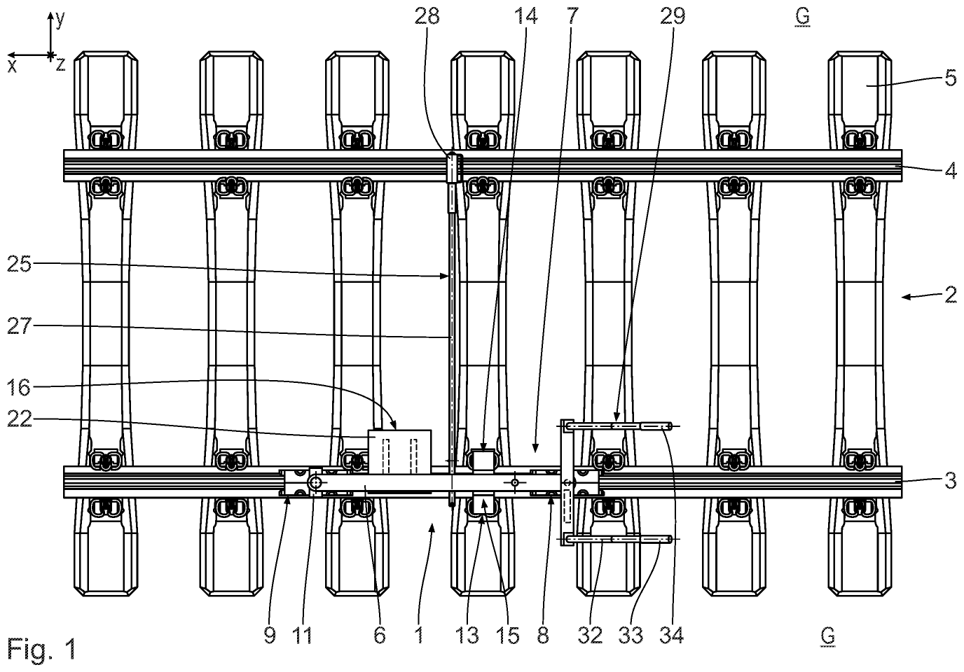

Referring now to the figures of the drawings in detail and first, particularly, to FIGS. 1-4 thereof, there is seen a first exemplary embodiment of the invention which is described below. The processing machine 1 shown in FIGS. 1 to 4 serves to process a track 2. The track 2 includes a first rail 3 and a second rail 4, which are fastened to sleepers 5. The rails 3, 4 extend in a longitudinal rail direction and are disposed at a distance from each other in a transverse rail direction running perpendicular to the longitudinal rail direction. The track 2 is surrounded by ground G.

The processing machine 1 includes a carrier 6, which defines a longitudinal direction x and a transverse direction y running perpendicular thereto. The carrier 6 extends substantially in the longitudinal direction x. The processing machine 1 further includes a displacement mechanism 7 disposed at the carrier 6.

The displacement mechanism 7 has a first rail-ground displacement unit 8 and a second rail-ground displacement unit 9. The first rail-ground displacement unit 8 is fastened to a first end of the carrier 6 by a fork-shaped first fastening element 10, whereas the second rail-ground displacement unit 9 is fastened to a second end of the carrier 6 by a fork-shaped second fastening element 11. The rail-ground displacement units 8, 9 serve to displace the carrier 6 on the rail 3.

The carrier 6, the rail-ground displacement units 8, 9 and the fastening elements 10, 11 delimit a receiving space 12, which is open on a side facing away from the carrier 6. The receiving space 12 serves to at least partially accommodate a first processing unit 13, a second processing unit 14, an associated positioning mechanism 15 and an associated energy supply unit 16.

The positioning mechanism 15 is fastened in a suspended manner to an underside of the carrier 6. The first processing unit 13 is fastened to the positioning mechanism 15 on a first side of the carrier 6 when viewed in the transverse direction y, whereas the second processing unit 14 is fastened to the positioning mechanism 15 on a second side of the carrier 6. The positioning mechanism 15 includes a first positioning drive 17 for positioning the first processing unit 13 and/or the second processing unit 14 in the transverse direction y. Furthermore, the positioning mechanism 15 includes a second positioning drive 18 for positioning the first processing unit 13 and the second processing unit 14 in a vertical direction z. The vertical direction z runs perpendicular to the longitudinal direction x and the transverse direction y. The longitudinal direction x, the transverse direction y and the vertical direction z form a Cartesian coordinate system.

The processing units 13, 14 serve, for example, for screwing. Alternatively, the processing units 13, 14 can also be configured for drilling, clipping, spike punching, spike pulling and/or grinding. The processing units 13, 14 are fastened in a suspended manner to the underside of the carrier 6 by using the positioning mechanism 15. The processing units 13, 14 each include a tool drive 19, which drives a processing tool 20 in rotation about an axis of rotation 21.

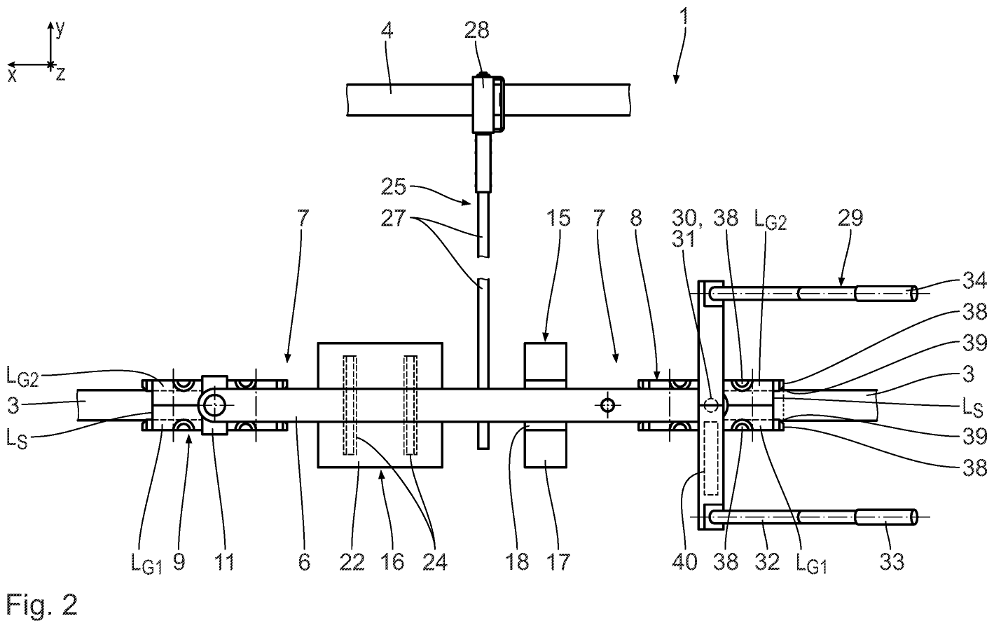

The energy supply unit 16 is disposed in a suspended manner at the carrier 6 in the longitudinal direction x between the positioning mechanism 15 and the second rail-ground displacement unit 9. The energy supply unit 16 includes a housing 22 in which a plurality of accumulators 23 are disposed. The accumulators 23 are connected in parallel and/or in series. The accumulators 23 serve to provide electrical energy. The energy supply unit 16 further includes an adjustment mechanism 24, which enables the position of the housing 22 relative to the carrier 6 to be adjusted in the transverse direction y. The adjustment mechanism 24 is configured, for example, as a linear guide. In particular, the linear guide can be locked in a desired position. FIG. 2 shows the housing 22 in a central position relative to the carrier 6, whereas FIG. 1 shows the housing 22 in a position displaced towards the adjacent rail 4.

The displacement mechanism 7 includes a cantilever beam 25. The

cantilever beam 25 is fastened to the carrier 6 in the longitudinal direction x between the processing units 13, 14 and the energy supply unit 16. The cantilever beam 25 has a holder 26, a transverse rod 27 and a supporting roller 28. The holder 26 is fastened to the carrier 6 and extends in the vertical direction z into the receiving space 12. The transverse rod 27, which extends in the transverse direction y to the adjacent rail 4, is detachably fastened to the holder 26. The supporting roller 28 is rotatably mounted at the free end of the transverse rod 27. The supporting roller 28 serves to support the carrier 6 and the rail-ground displacement units 8, 9 disposed thereon on the adjacent rail 4. This is illustrated in FIG. 1.

The displacement mechanism 7 includes a steering unit 29 for swiveling the first rail-ground displacement unit 8 about a vertical swivel axis 30. The steering unit 29 includes a swivel bearing 31, a steering linkage 32 and handles 33, 34. The fork-shaped fastening element 10 is mounted on the carrier 6 so that it can be swiveled about the swivel axis 30 by the swivel bearing 31. The steering linkage 32 is fastened to the fork-shaped fastening element 10. The steering linkage 32 is constructed in a U-shape. The first handle 33 and the second handle 34 are fastened to the free ends of the steering linkage 32. The handles 33, 34 serve to guide and steer the processing machine 1 on the rail 3 or rails 3, 4 and on the ground G surrounding the track 2. The second rail-ground displacement unit 9 is disposed on the carrier 6 so that it cannot be steered. For this purpose, the fork-shaped fastening element 11 is firmly connected to the carrier 6.

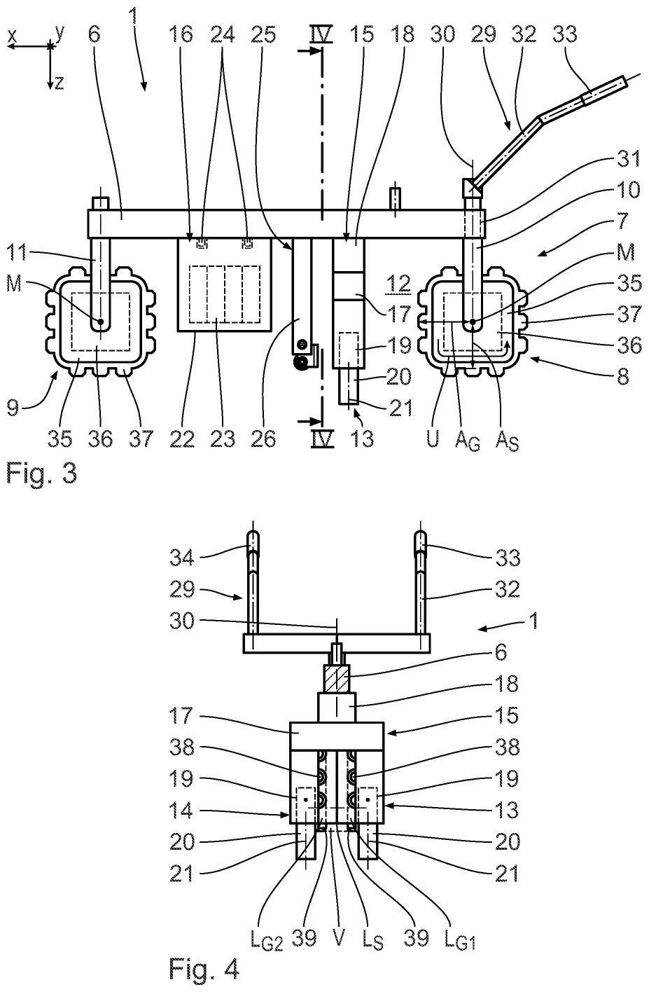

The rail-ground displacement units 8, 9 are constructed identically, so that only the rail-ground displacement unit 8 is described in detail below. The rail-ground displacement unit 8 includes a displacement base body 35, a displacement drive 36 and a contact element 37. The displacement base body 35 is fastened to the fastening element 10 or 11 and cannot be rotated relative to the latter. The displacement base body 35 is polygonal in cross-section, in particular rectangular, and in particular square, and has rounded corners. The displacement base body 35 defines a central longitudinal axis M. In the steering position shown in FIG. 3, the central longitudinal axis M runs parallel to the transverse direction y. The contact element 37 extends in a circumferential direction U around the displacement base body 35 and has a closed shape. The contact element 37 is configured in particular as a chain and/or belt. The contact element 37 can be displaced relative to the displacement base body 35 in the circumferential direction U about the central longitudinal axis M by using the displacement drive 36. The displacement drive 36 is integrated into the displacement base body 35. The contact element 37 is made, for example, of a rubber material.

The respective contact element 37 forms a running surface which includes a first ground running surface L_{G1}, a rail running surface L_{S} and a second ground running surface L_{G2} in the transverse direction y or in the direction of the central longitudinal axis M. The rail running surface L_{S} is disposed in the direction of the central longitudinal axis M between the ground running surfaces L_{G1}, L_{G2}. The ground running surfaces L_{G1}, L_{G2} and the rail running surface L_{S} run around the central longitudinal axis M or the displacement base body 35 in accordance with the contact element 37.

The ground running surfaces L_{G1}, L_{G2} are configured to be profiled in the circumferential direction U and in the direction of the central longitudinal axis M. For this purpose, the contact element 37 has elevations 38, which are configured as nubs or studs, for example. The elevations 38 at least partially form the ground running surfaces L_{G1}, L_{G2}. The ground running surfaces L_{G1}, L_{G2} have a maximum distance A_{G} from the central longitudinal axis M, whereas the rail running surface L_{S} has a maximum distance A_{S} from the central longitudinal axis M. The following applies: A_{G}>A_{S}. For the distance A_{G}, in particular: 5 cm≤A_{G}≤30 cm, in particular 10 cm≤A_{G}≤25 cm, and in particular 15 cm≤A_{G}≤20 cm. For the distance A_{S}, in particular: 4 cm≤A_{S}≤29 cm, in particular 9 cm≤A_{S}≤24 cm, and in particular 14 cm≤A_{S}≤19 cm. For a difference ΔA=A_{G}−A_{S}, in particular: 1 cm≤ΔA≤8 cm, in particular 2 cm≤ΔA≤7 cm, and in particular 3 cm≤ΔA≤6 cm.

The running surfaces define in cross-section, at least in sections, a recess V for receiving a rail head of the rail 3. The recess V widens in cross-section in a direction transverse to the central longitudinal axis M. For this purpose, the elevations 38 have a chamfer and/or a rounding in a region 39 facing the rail running surface L_{S}. Due to the widening cross-section of the recess V, rail heads of different widths can be accommodated.

The first positioning drive 17, the second positioning drive 18, the tool drives 19 and the displacement drives 36 are configured electrically, in particular. For controlling, the processing machine 1 includes a control mechanism 40, which is disposed at the steering linkage 32.

The operating principle of the processing machine 1 is as follows:

For track processing, the processing machine 1 must first be moved to the track 2 or track section to be processed. For this purpose, the transverse rod 27 and the supporting roller 28 disposed thereon are first removed from the holder 26. The processing machine 1 is displaced or moved to the track 2 by an operator on the ground G by using the rail-ground displacement units 8, 9. For this purpose, the contact elements 37 are displaced in the circumferential direction U around the respective displacement base body 35 by using the displacement drives 36. Through the use of the steering unit 29, the operator can steer the processing machine 1 in a desired direction. Due to the ground running surfaces L_{G1}, L_{G2}, the processing machine 1 has sufficient grip on the ground G, so that the rail-ground displacement units 8, 9 have good traction on the ground G. Due to the fact that the distance A_{G} is greater than the distance A_{S}, the rail running surface L_{S} is simultaneously protected from damage on the ground G.

If the processing machine 1 is located on the track 2, the processing machine 1 is manually lifted onto the rail 3 or moved onto the rail 3 with the aid of the rail-ground displacement units 8, 9 and the transverse rod 27 with the supporting roller 28 is mounted on the holder 26 so that the processing machine 1 is supported on the adjacent rail 4 by the cantilever beam 25. In order to increase the stable position of the processing machine 1, the housing 22 with the accumulators 23 disposed therein is shifted towards the rail 4 by using the adjustment mechanism 24, so that the center of gravity of the processing machine 1 is located between the rails 3, 4.

The rail head of the rail 3 is now located in the recesses V of the running surfaces, wherein the rail running surfaces L_{S} of the rail-ground displacement units 8, 9 rest on the rail head of the rail 3. The ground running surfaces L_{G1}, L_{G2} rest laterally against the rail head and center the rail-ground displacement units 8, 9 on the rail 3.

The processing units 13, 14 can now be adjusted in the transverse direction y using the positioning mechanism 15. Track processing subsequently takes place. For this purpose, the processing units 13, 14 are lowered in the vertical direction z, the processing tools 20 are driven in rotation by the tool drives 19 and then the processing units 13, 14 are lifted again. The processing machine 1 is now moved by the rail-ground displacement units 8, 9 in the longitudinal rail direction to the next track section to be processed, where the track processing described above is repeated.

Once track processing is finished, the processing machine 1 is removed from the track. For this purpose, the housing 22 with the accumulators 23 is first brought back into a central position relative to the carrier 6 by the adjustment mechanism 24. The transverse rod 27 with the supporting roller 28 is then dismantled from the holder 26 and the processing machine 1 is lifted manually from the rail 3 or moved off the rail 3 using the rail-ground displacement units 8, 9. The processing machine 1 can now be moved on the ground G in the manner already described.

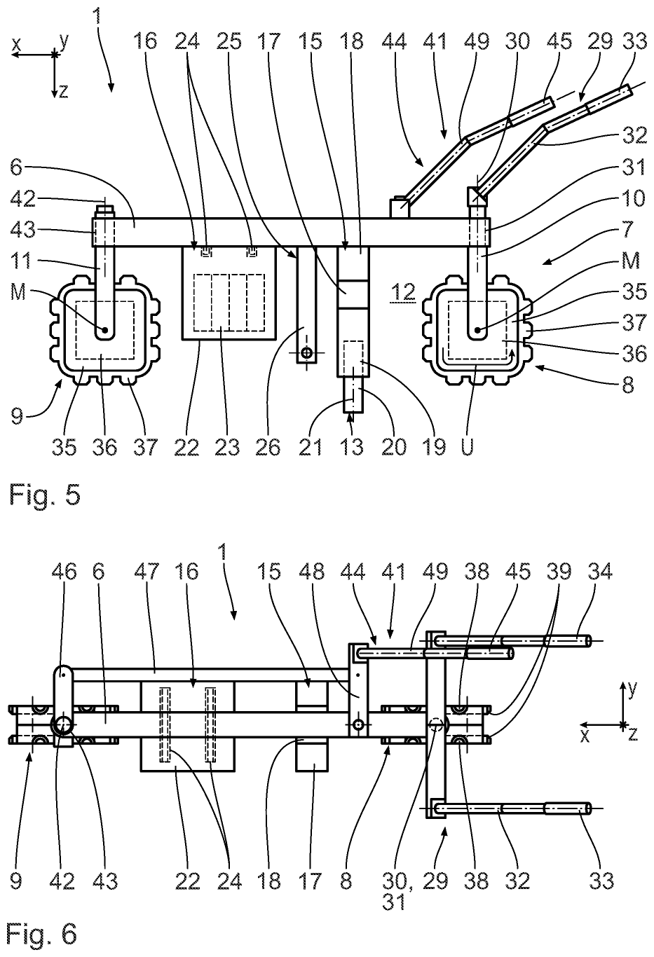

A second exemplary embodiment of the invention is described below with reference to FIGS. 5 to 8. In contrast to the first exemplary embodiment, the processing machine 1 has, in addition to the first steering unit 29, a second steering unit 41 for swiveling the second rail-ground displacement unit 9 about a vertical swivel axis 42. The second steering unit 41 includes a swivel bearing 43, a steering linkage 44 and a third handle 45. The fork-shaped fastening element 11 is mounted on the carrier 6 so as to be swivelable about the swivel axis 42 by the swivel bearing 43. The steering linkage 44 includes a first transverse rod 46, a first longitudinal rod 47, a second transverse rod 48 and a second longitudinal rod 49. The first transverse rod 46 is non-rotatably connected to the second fastening element 11. The first longitudinal rod 47 is articulated to the first transverse rod 46 and to the second transverse rod 48, wherein the second transverse rod 48 is in turn articulated to the carrier 6. In this way, the carrier 6, the first transverse rod 46, the first longitudinal rod 47 and the second transverse rod 48 form a parallel guide. The second longitudinal rod 49 is fastened to the second transverse rod 48 at a distance from the carrier 6 in the transverse direction y and serves to actuate the parallel guide. The third handle 45 is fastened to the second longitudinal rod 49. The second steering unit 41 can be locked in a desired swiveling position steplessly or in steps.

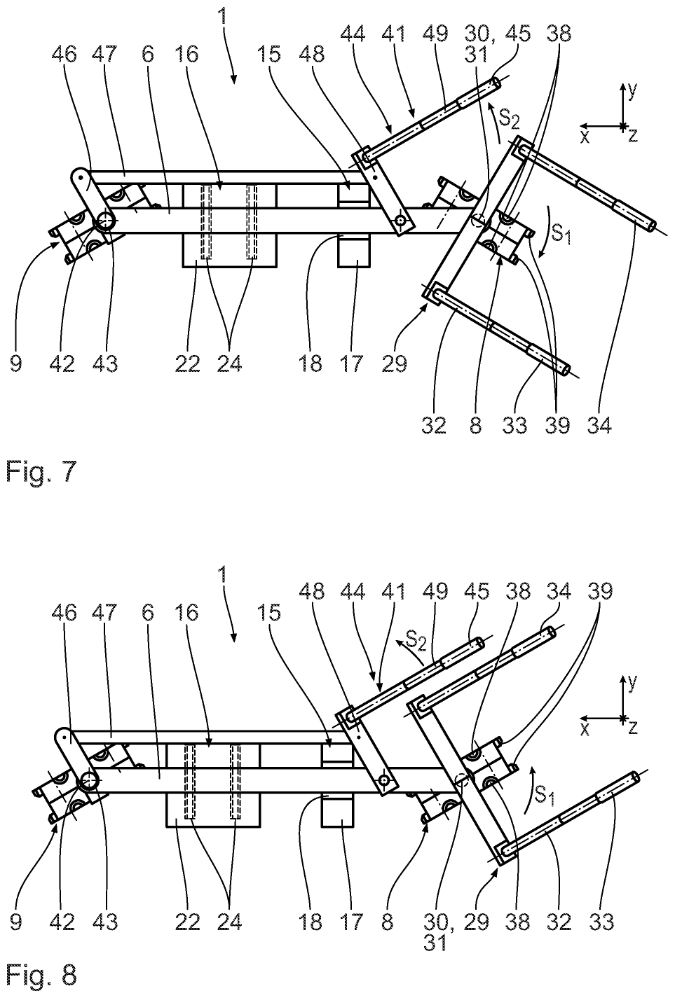

In a first steering position, which is shown in FIG. 7, the steering units 29, 41 are actuated in different swiveling directions S₁ and S₂, so that the rail-ground displacement units 8, 9 are swiveled in opposite directions to each other. This allows the processing machine 1 to be moved around tight curves. In the first steering position, the processing machine 1 can thus travel round a curve with a small turning radius.

In a second steering position, which is shown in FIG. 8, the steering units 29, 41 are swiveled in the same swivel directions S₁, S₂ about the swivel axes 30, 42, so that the rail-ground displacement units 8, 9 are swiveled synchronously with one another. As a result, the rail-ground displacement units 8, 9 are aligned substantially parallel to one another, so that the processing machine 1 is moved linearly and at an incline, i.e. is transversely displaced. With regard to the further structure and the further operating principle of the processing machine 1, reference is made to the preceding exemplary embodiment.

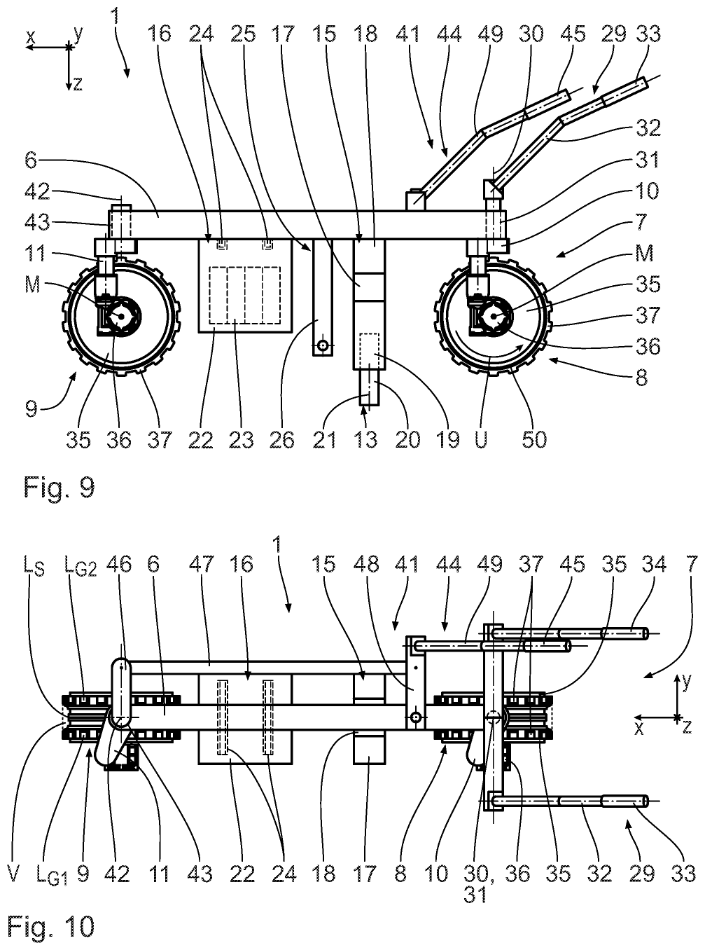

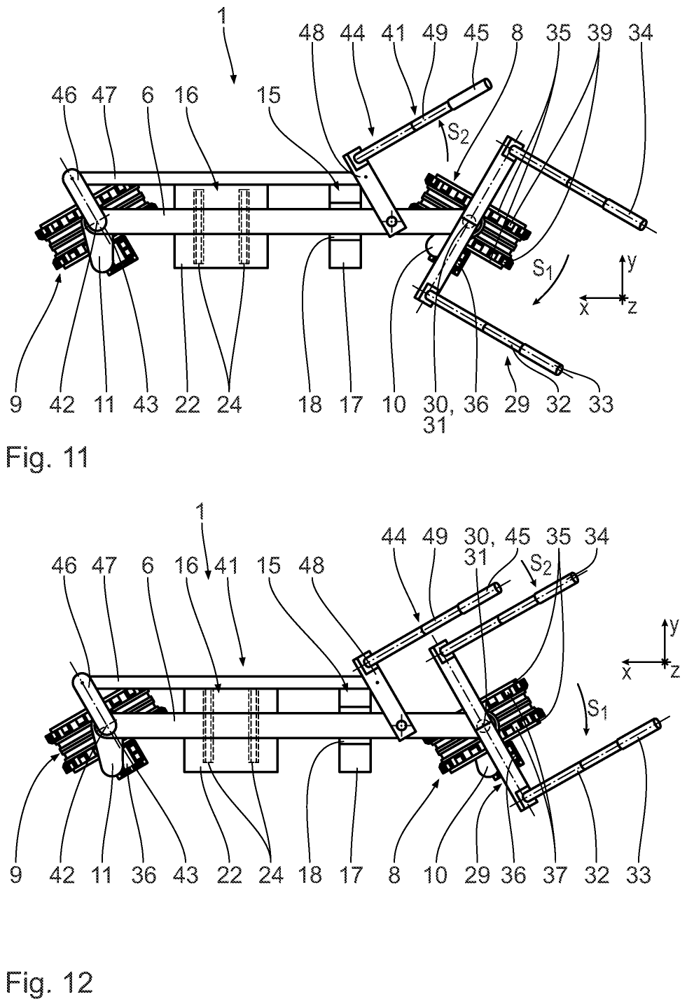

A third exemplary embodiment of the invention is described below with reference to FIGS. 9 to 14. According to the second exemplary embodiment, the processing machine 1 has a first steering unit 29 for swiveling the first rail-ground displacement unit 8 and a second steering unit 41 for swiveling the second rail-ground displacement unit 9. FIG. 11 shows the processing machine in the first steering position, whereas FIG. 12 shows the processing unit 1 in the second steering position.

The first rail-ground displacement unit 8 is fastened to the carrier 6 on one side and rotatable about the central longitudinal axis M by the fastening element 10. Correspondingly, the second rail-ground displacement unit 9 is fastened to the carrier 6 on one side and rotatable about the central longitudinal axis M by the fastening element 11.

The rail-ground displacement units 8, 9 are constructed identically, so that only the rail-ground displacement unit 8 is described below. The rail-ground displacement unit 8 has a wheel-shaped or cross-sectionally round displacement base body 36, which can be driven in rotation about the central longitudinal axis M by the associated displacement drive 36. Ring-shaped contact elements 37 are fastened to the displacement base body 35 by threaded connections 50. The ring-shaped contact elements 37 form the ground running surfaces L_{G1}, L_{G2}, whereas the displacement base body 35 forms the rail running surface L_{S} disposed therebetween. The contact elements 37 are constructed to be profiled in the circumferential direction U and in the direction of the central longitudinal axis M and have the elevations 38. The contact elements 37 form cheeks for the displacement base body 35.

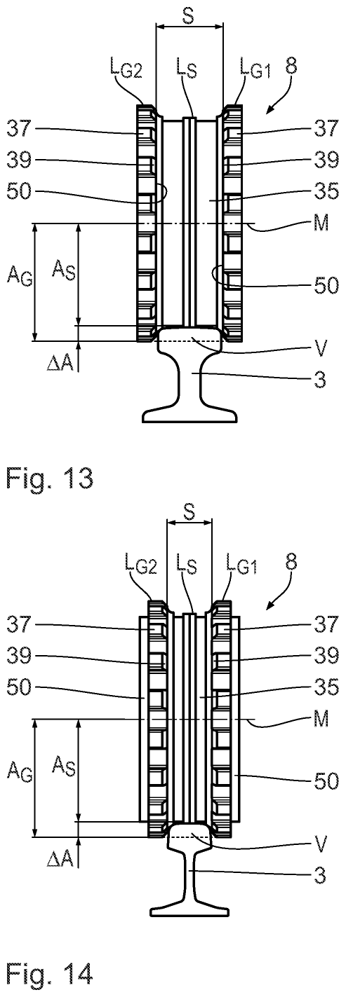

The contact elements 37 can be adjusted relative to the displacement base body 35 in the direction of the central longitudinal axis M by the respective threaded connection 50, so that the recess V can be adapted to rail heads of different widths on the rail 3. This is illustrated in FIGS. 13 and 14. A distance s between the contact elements 37 can thus be adjusted in the direction of the central longitudinal axis M. For this purpose, the contact elements 37 can be locked in the desired position relative to the displacement base body 35. With regard to the further structure and the further operating principle, reference is made to the preceding exemplary embodiments.

1. A processing machine for track processing, the processing machine comprising:
a carrier;
a displacement mechanism disposed at said carrier, said displacement mechanism including at least one rail-ground displacement unit for displacing the processing machine on a rail and on the ground;
at least one processing unit disposed at said carrier for processing a track; and
at least one handle for manually guiding the processing machine.

2. The processing machine according to claim 1, wherein said at least one rail-ground displacement unit forms a running surface including at least one ground running surface and at least one rail running surface.

3. The processing machine according to claim 1, wherein said at least one rail-ground displacement unit forms a running surface including two ground running surfaces and a rail running surface disposed between said two ground running surfaces.

4. The processing machine according to claim 1, wherein said at least one rail-ground displacement unit forms a running surface with a recess for receiving a rail head of a rail.

5. The processing machine according to claim 1, wherein said at least one rail-ground displacement unit includes a displacement drive.

6. The processing machine according to claim 1, wherein said displacement mechanism includes at least one steering unit.

7. The processing machine according to claim 1, wherein said at least one rail-ground displacement unit includes a first rail-ground displacement unit and a second rail-ground displacement unit disposed at a distance from one another in a longitudinal direction at said carrier.

8. The processing machine according to claim 7, wherein said at least one processing unit is disposed between said first rail-ground displacement unit and said second rail-ground displacement unit in a longitudinal direction.

9. The processing machine according to claim 7, wherein said displacement mechanism includes a first steering unit for swiveling said first rail-ground displacement unit and a second steering unit for swiveling said second rail-ground displacement unit relative to said carrier.

10. The processing machine according to claim 1, wherein said at least one processing unit is suspended at said carrier.

11. The processing machine according to claim 1, wherein said carrier has first and second opposite sides, and said at least one processing unit includes a first processing unit disposed in a transverse direction on said first side of said carrier and a second processing unit disposed on said second side of said carrier.

12. The processing machine according to claim 1, which further comprises a positioning mechanism for positioning said at least one processing unit.

13. The processing machine according to claim 1, wherein said displacement mechanism includes a cantilever beam configured to be supported on a rail.

14. The processing machine according to claim 1, which further comprises a power supply unit.

15. The processing machine according to claim 14, wherein said power supply unit is disposed at said carrier.

16. A method for track processing, the method comprising steps of:
providing the processing machine according to claim 1;
displacing the processing machine on the ground to a track and on a rail of the track by using said at least one rail-ground displacement unit; and
processing the track by using said at least one processing unit.
